(19) United States
(12) Patent Application Publication
(10) Pub. No.: US 2014/0052850 A1
(43) Pub. Date: Feb. 20, 2014

(54) Datacenter Capacity Planning and Management

(71) Applicant: Panduit Corp., Tinley Park, IL (US)

(72) Inventors: Brendan F. Doorhy, Westmont, IL (US); Sambodhi Chatterjee, Naperville, IL (US); Zeshun Cai, Skokie, IL (US); Robert Wilcox, Monee, IL (US)

(73) Assignee: PANDUIT CORP., Tinley Park, IL (US)

(21) Appl. No.: 13/964,611

(22) Filed: Aug. 12, 2013

Related U.S. Application Data
(60) Provisional application No. 61/682,460, filed on Aug. 13, 2012.

(51) Int. Cl. H04L 12/26

(52) U.S. Cl. CPC H04L 43/0876
USPC 709/224

(57) ABSTRACT

The present invention relates to the field of facility management, and more specifically, to methods and systems for datacenter capacity monitoring and planning. Embodiments of the present invention utilize various environmental variables to help execute and plan move/add/change work orders within a datacenter while remaining within desired guard bands.

### CROSS-REFERENCE TO RELATED APPLICATIONS

This application claims the benefit of U.S. Provisional Patent Application No. 61/682,460, filed on Aug. 13, 2012, which is incorporated herein by reference in its entirety.

This application further incorporates by reference in its entirety U.S. patent application Ser. No. 13/306,606, entitled “Physical Infrastructure Management System Having an Integrated Cabinet,” filed Nov. 29, 2011.

### FIELD OF INVENTION

The present invention relates to the field of facility management, and more specifically, to methods and systems for datacenter capacity monitoring and planning.

### BACKGROUND

As personal and business computing has undergone an evolutionary shift over the years, an ever-increasing amount of information is being transferred over electronic networks. This influx in data transfer has necessitated larger and more powerful networks, at the center of which are often datacenters, housing complex and expensive computer and network equipment. Given the large scale nature of many datacenters and the amount of equipment housed therein, available space, power consumption, weight distribution, connectivity, and cooling are among the concerns that must be taken into account to ensure extended uptime, reliable performance, ease of maintenance, and scalability. Furthermore, when datacenter expansion occurs, datacenter managers often face the challenge of complex capacity planning.

In light of these concerns, understanding the interdependencies between space, power, weight, connectivity, and cooling in the datacenter environment can be critical to knowing how many more servers, storage units, or switches a particular datacenter can take before requiring some form of an infrastructure upgrade. Therefore, there exists a need for methods and systems capable of monitoring various aspects of a datacenter and providing feedback models based on the monitored elements.

### SUMMARY OF INVENTION

In one embodiment, the present invention is designed to meet the needs of rapidly growing enterprises as they expand datacenters to align with their business requirements.

In another embodiment, the present invention can simplify datacenter capacity planning from the user's end and help provide the following information: 1) the available physical infrastructure location(s) for new service requests that meet user-defined SLAs (service-level agreements), the new service requests being requests to install network equipment such as, but not limited to, servers, switches, routers, disk arrays, and Network Attached Storage (NAS) systems; 2) the total capacity in the datacenter, where capacity may refer to any environmental variable capable of being monitored; 3) the amount of capacity that is being used and the amount remaining available; 4) temporal information regarding when the amount of the total, utilized, and/or available capacity can, may, and/or will change; and 5) forecasting for new service requests. The forecast of new service requests may help estimate how the newly added equipment will impact the capacity of a datacenter.

In yet another embodiment, the present invention may help improve the efficiency of equipment placement through the adjustments of guard bands over the life of a datacenter. This may be accomplished by lessening the guard band restrictions over time, thereby allowing additional equipment installations.

In still yet another embodiment, the present invention may help increase the uptime of a datacenter through overprovisioning. This may be accomplished by allowing a user to more-easily remain within chosen capacity guard bands while planning and/or executing service requests.

In still yet another embodiment, the present invention is a system for monitoring at least one datacenter variable, where the system includes at least one processor; and a computer readable medium connected to the at least one processor. The computer readable medium includes instructions for collecting respective input information associated with a plurality of the datacenter variables, analyzing at least one work order associated with the datacenter, projecting consumption of at least one the datacenter variable based on the work order, and forecasting at least one of a capacity and a utilization of at least one the datacenter variable.

In still yet another embodiment, the present invention is a method of forecasting at least one datacenter variable, the method including the steps of: collecting respective input information associated with a plurality of said datacenter variables; analyzing at least one work order associated with said datacenter; projecting consumption of at least one said datacenter variable based on a work order; and predicting at least one of a capacity and a utilization of at least one said datacenter variable.

These and other features, aspects, and advantages of the present invention will become better-understood with reference to the following drawings, description, and any claims that may follow.

### BRIEF DESCRIPTION OF THE DRAWINGS

FIG. 1 illustrates a dashboard according to an embodiment of the present invention.

FIG. 2 illustrates a forecast according to an embodiment of the present invention.

FIG. 3 illustrates a task manager according to an embodiment of the present invention.

FIG. 4 illustrates a search module according to an embodiment of the present invention.

FIG. 5 illustrates a search-results module according to an embodiment of the present invention.

FIG. 6 illustrates a what-if planning module according to an embodiment of the present invention.

FIG. 7 illustrates a what-if planning module according to another embodiment of the present invention.

FIG. 8 illustrates a datacenter map module according to an embodiment of the present invention.

FIG. 9 illustrates a virtual rack module according to an embodiment of the present invention.

FIG. 10 illustrates an infrastructure manager module according to an embodiment of the present invention.

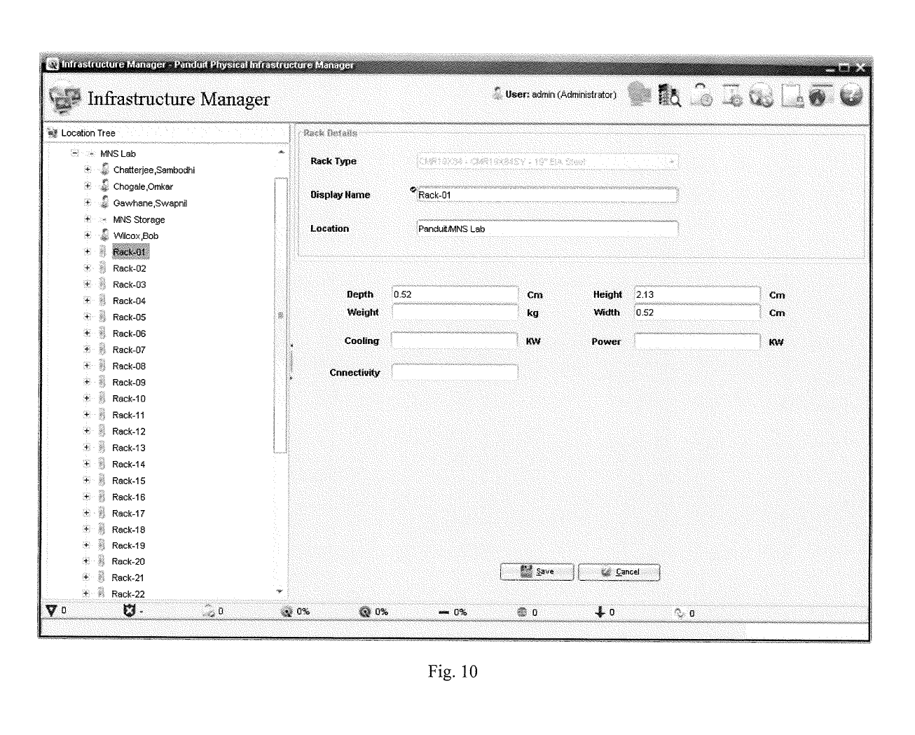

FIG. 11 illustrates a portion of the infrastructure manager module of FIG. 10 in use by a user according to an embodiment of the present invention.

FIG. 12 illustrates a provisioning module according to an embodiment of the present invention.

FIG. 13 illustrates an infrastructure manager module according to another embodiment of the present invention.

### DETAILED DESCRIPTION

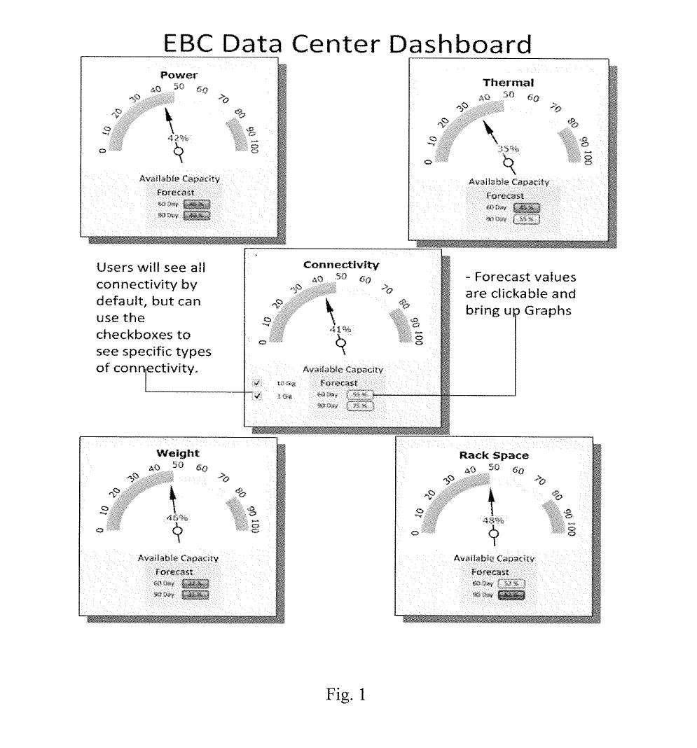

In one embodiment, the present invention is a system that includes means for real-time monitoring of at least one datacenter environmental variable, and a plurality of modules which allow a user to interact with the system and perform at least one of: viewing the real-time status of at least one environmental variable; forecasting at least one environmental variable in response to a change in the datacenter equipment; and satisfying queries in connection with physical placement of to-be-installed datacenter network equipment. As used herein, “real-time” may be understood as instantaneous or near-instantaneous. The modules can be a part of a computerized system capable of being operated on a server or workstation computer, or any other electronic device which can provide the necessary interaction between the user and the system of the present invention. FIG. 1 illustrates an exemplary DataCenter Dashboard (dashboard) module in accordance with an embodiment of the present invention. The dashboard module can display the real-time status of at least one datacenter environmental variable. The dashboard module illustrated in FIG. 1 is shown displaying five datacenter environmental variables: (1) power, (2) thermal, (3) connectivity, (4) weight, and (5) rack space. Each of these five readouts shows capacity utilization and availability measurements (shown in percentages) for the cabinets in a datacenter. Depending on the embodiment, the present invention may monitor any number of cabinets, including a single cabinet, a subset of cabinets located in a portion of a datacenter, an entire datacenter, or a plurality of datacenters.

For example, the thermal capacity measurement of FIG. 1 shows the thermal capacity utilization to be about 35%, which means that about 65% of the total thermal capacity remains available. The dashboard can also provide a forecast of where the capacities will be in 60 or 90 days. In alternate embodiments, the forecasting displayed on the dashboard can be varied in any desirable manner, including, but not limited to, increasing or decreasing the number of forecasts provided for any of the environmental variables, and increasing or decreasing the number of days for any forecast. In one embodiment, a forecast will be shown if and when the user selects a trigger to view that particular forecast. This can be done by associating a check-box that can be checked on (to show the forecast) or off (to hide the forecast) by way of a computer and its supporting equipment. In other embodiments, any number of forecasts can be shown automatically upon entry into the dashboard.

For environmental variables which may have more than one subset (such as, for example, the connectivity variable where the datacenter may include 1 Gigabit Ethernet connectivity and 10 Gigabit Ethernet connectivity throughout), the capacity displayed on the dashboard can be configured to show any combination desired by the user. Therefore, in the exemplary dashboard of FIG. 1, the user may select the option to view the connectivity capacity measurements for just the 1 Gigabit Ethernet connectivity, the connectivity capacity for just the 10 Gigabit Ethernet connectivity, or a combined connectivity capacity for both the 1 and 10 Gigabit Ethernet connectivity.

In the present embodiment, different levels of capacity availability/utilization (also referred to as guard bands or bands) for power, thermal, connectivity, weight, and rack space are represented by three colors. These colors can generally signify a particular level of criticality associated with capacity utilization and availability, and can be defined at the time of a SLA (service-level agreement) between a service provider and a customer, or any time thereafter. For example, green or gold may be considered low capacity utilization and high capacity availability; yellow or silver may be considered moderate capacity utilization and moderate capacity availability; and red or bronze may be considered critical or high capacity utilization and low or no capacity availability. In alternate embodiments, green or gold may be considered high overprovisioning, yellow or silver may be considered moderate overprovisioning, and red or bronze may be considered low overprovisioning, where the more critical resources require a higher level of overprovisioning. Furthermore, the band ranges can be defined depending on any particular user's needs, by setting up the transition points between the various criticality levels at any desired percentage for any particular environmental variable. Alternate embodiments of the invention can display specific values of environmental variables rather than percentages. For example, the “Thermal” environmental variable can be shown as a range from 40 degrees to 100 degrees Fahrenheit.

Referring to the dashboard of FIG. 1, the power variable (upper left corner) shows the power utilization to be about 42%. This means that the monitored network equipment is taking up about 42% of the total available power, leaving about 58% of the total power available. The dashboard of FIG. 1 has been configured such that from 0 to 50% is marked as low capacity utilization, 50 to 80% is marked as moderate capacity utilization, and 80 to 100% is marked as critical capacity utilization. Note that FIG. 1 is exemplary and the gauges shown therein can be illustrated in any number of ways while staying within the scope of the present invention. For example, the various capacity levels can be illustrated by any number of analog and/or digital gauges or gauge-like displays.

As noted previously, the embodiment illustrated by FIG. 1 includes a forecast for the available Rack Space, which shows capacity utilization to be estimated at about 52% in 60 days (surpassing the minimum level for moderate capacity utilization, which is set to 50%) and about 82% in 90 days (surpassing the minimum level for critical capacity utilization, which is set to 80%). The user may elect to view a detailed model of this forecast. In one embodiment, a detailed forecast modeled can be accessed by selecting (clicking) a respective forecast on the dashboard.

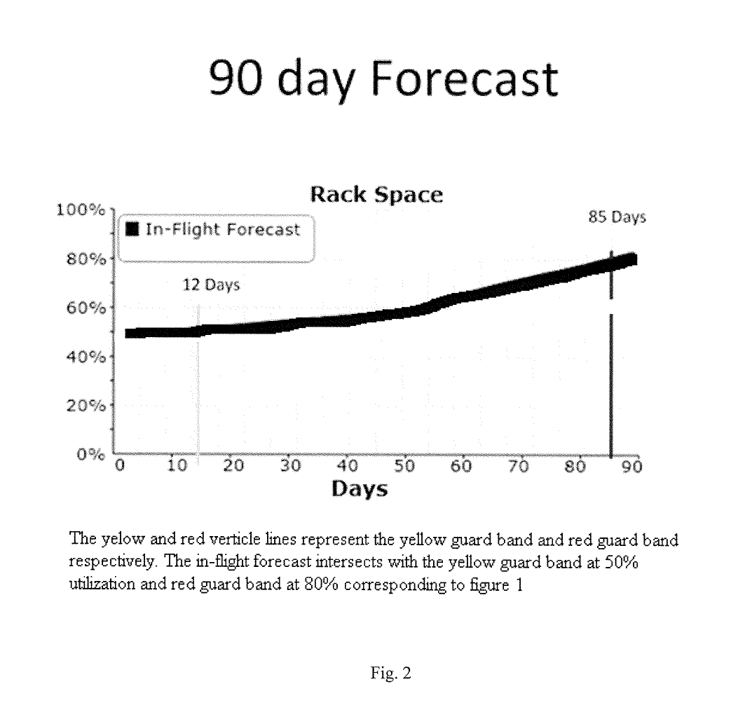

An embodiment of a detailed forecast model module is illustrated in FIG. 2, showing a 90-day forecast plot of rack space utilization within the datacenter. The in-flight forecast line indicates the estimated rack space utilization for upcoming equipment installations. The Y-axis represents the rack space utilization percentage, and the X-axis represents the timeline shown in days. While the detailed model is illustrated as a forecast of the Rack Space, such a model can be developed for any one or more environmental variables that are monitored by the system of the present invention. Alternate embodiments of the invention may utilize actual environmental values rather than percentages on the Y-axis. Similarly, the timeline may be represented in any desirable fashion, including, but not limited to, hours, weeks, and months. Note that the graph of FIG. 2 is exemplary, and the projection of the capacity over a certain amount of time can be illustrated in any number of graphical, tabular, or other detailed ways while staying within the scope of the present invention.

Based on the model shown in FIG. 2, the user can observe that there are 12 days until the estimated rack space capacity utilization reaches the moderate threshold, and 85 days until the estimated capacity utilization reaches the critical threshold. As mentioned previously, the rack space guard bands have been defined as follows: 0 to 50% is low capacity utilization, 50 to 80% is moderate capacity utilization, and 80 to 100% is critical capacity utilization. At day 12, the in-flight forecast line reaches the moderate capacity utilization level of 50%. This can be illustrated by a vertical line extending along the Y-axis and crossing the forecast line at day 12. At day 85, the in-flight forecast line reaches the critical capacity utilization of 80%. Similarly, this occurrence can be illustrated by a vertical line extending along the Y-axis and crossing the forecast line at day 85. The vertical lines may be of the same color as the corresponding guard bands for various capacities. This model can offer the user the ability to view detailed datacenter capacity utilization/availability forecasts based on previously saved and/or real-time requests made in infrastructure management software such as Panduit's Physical Infrastructure Manager (PIM). Real-time (or also known as in-flight) requests can include work order requests entered by a user and assigned to a technician or another party for execution.

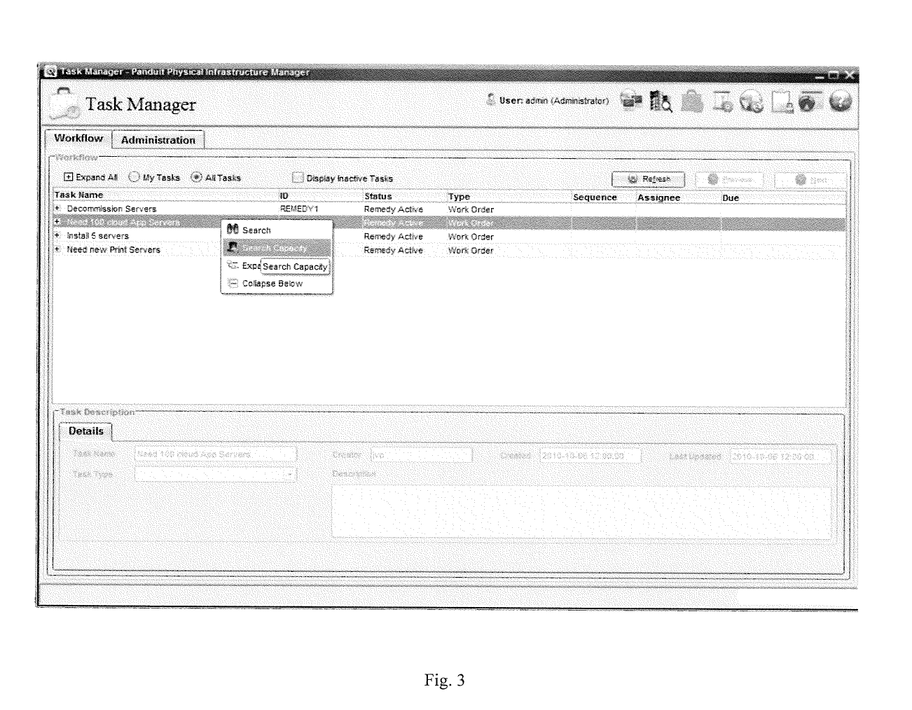

FIG. 3 illustrates a task manager module according to one embodiment of the system of the present invention. In this module, the user can see the pending and executed service requests (also referred to as tasks). In one embodiment, these service requests originate via entries made in infrastructure management software by a user such as a datacenter manager or a technician. Directly from this module, the user can also perform search operations to help fulfill a service request. One example of such a search would be a capacity search which may help determine the availability of space within a datacenter for networking equipment based on one or more criteria. The requested task selected in FIG. 3 is to add 100 cloud application servers to the datacenter. The user can select the task (left-clicking the task to generate a menu) and search the datacenter to determine physical locations that can satisfy the service request.

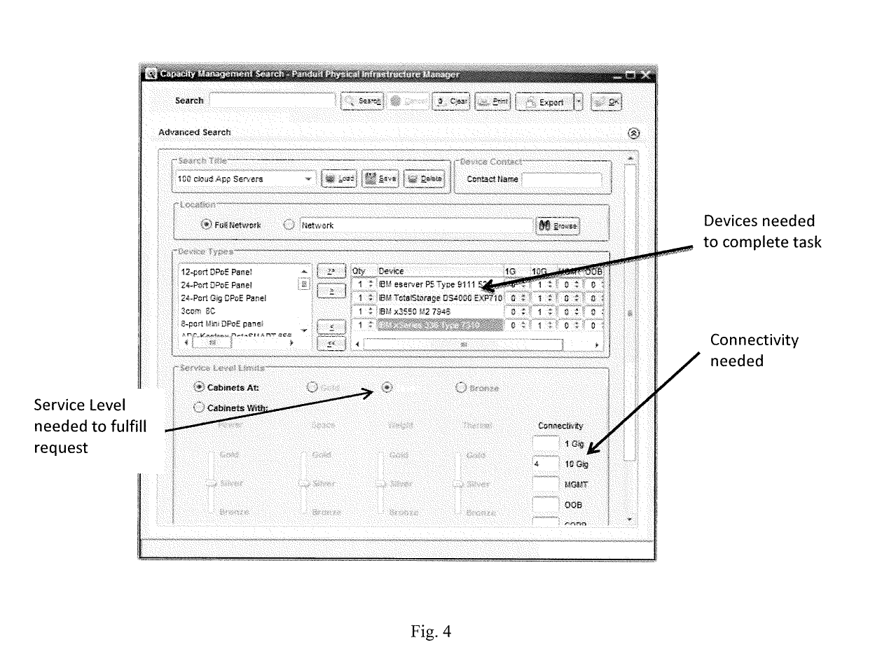

After a search option is selected, information related to the task request can be automatically populated into a capacity search module, as illustrated in FIG. 4. Alternatively, information needed to satisfy the search query can be entered manually. When searching for available physical locations, it may be desirable to narrow the search down to locations that are within a certain capacity utilization level. The present invention can provide the user with two options for achieving this.

For the first option, the user may individually specify the desired guard band levels for the capacity utilization of each environmental variable. For example, setting the “power” variable at “gold” and the “space” variable at “bronze,” the search results will be limited to physical locations having a real-time status of low capacity utilization for the “power” variable, and low, moderate, or critical capacity utilization for the “space” variable. In essence, the guard band level selected during the search acts as an upper limit, restricting the search results to any locations having the selected or better capacity utilization (with low capacity utilization being better than moderate capacity utilization, and moderate capacity utilization being better than critical capacity utilization). For the second option, the user may select an overall guard band level where only physical locations having the selected guard band levels or better are returned in the search results. For example, a search with a general guard band level of moderate (silver) capacity utilization will return results for physical locations where every monitored environmental variable has a real-time status of low or moderate capacity utilization. If any one of the monitored variables for a particular physical location has a capacity utilization status which is considered worse than specified in the search request (which in the present example would be critical (bronze) capacity utilization) that physical location will not be returned in the search results.

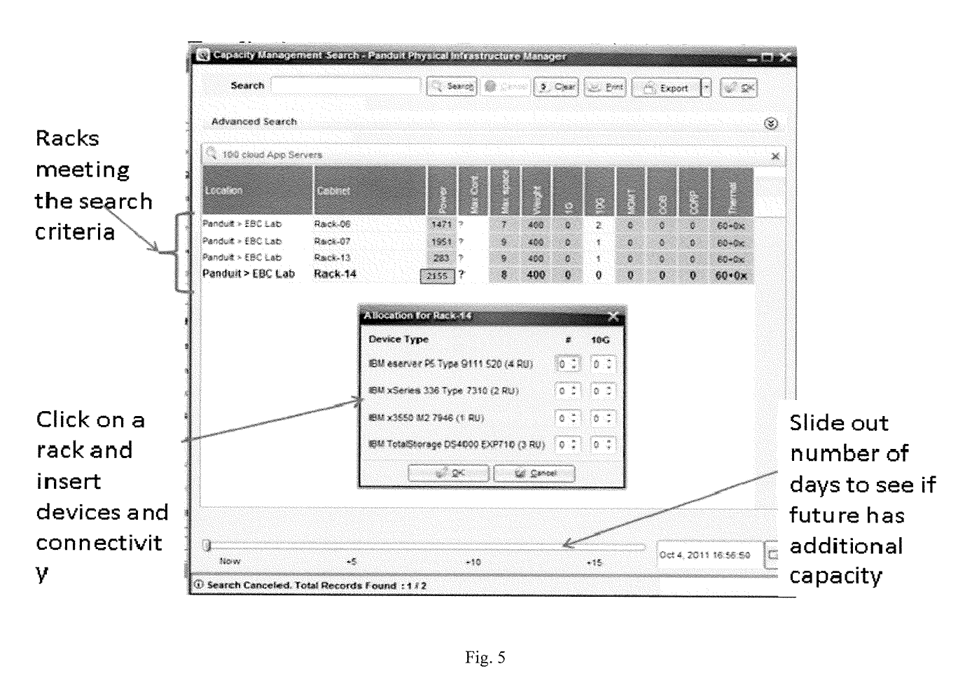

In response to an inquiry submitted through the capacity search module, the user receives a list of datacenter racks that meet the search criteria in a search-results module. An exemplary search-results module is shown in FIG. 5 where four racks meeting the search criteria are highlighted silver: rack-06, rack-07, rack-13, and rack-14. Although most of the rack attribute fields are highlighted gold, in the present embodiment, the rack level is determined by the lowest attribute rating, where bronze is the lowest rating and gold is the highest. For example, the 10 G port column is highlighted silver and the rest of the attribute columns are highlighted gold, hence the racks are highlighting silver. If one of the rack's capacity attributes is rated bronze, then the rack is also rated bronze.

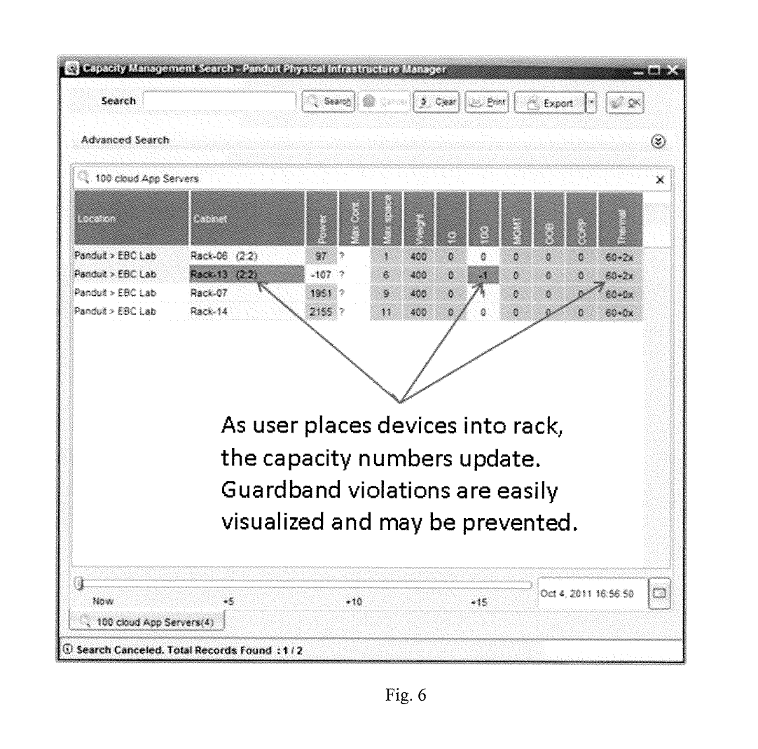

After receiving the results, the user can select the rack (by clicking it) and virtually insert therein devices and the required connectivity. FIG. 5 shows an embodiment of the menu that is brought up if a user chooses to install devices into rack-14. As the user inserts various devices, the rack's capacity attributes are updated within the system of the present invention. The results of the virtual additions can be shown on a “What-if? Planning” module, an example of which is shown in FIG. 6. Here, we can see that the user inserted two devices into rack-06 and two devices into rack-14 and correspondingly reserved one 10 G port for every device inserted into the respective rack. Prior to the additions, rack-06 had a total of two available 10 G ports and rack-13 had one available 10 G port. After the device additions, the user can see that the port numbers have been updated, and that the 10 G port attribute for rack-13 is highlighted bronze as a result of going below a pre-defined limit for a silver guard band range.

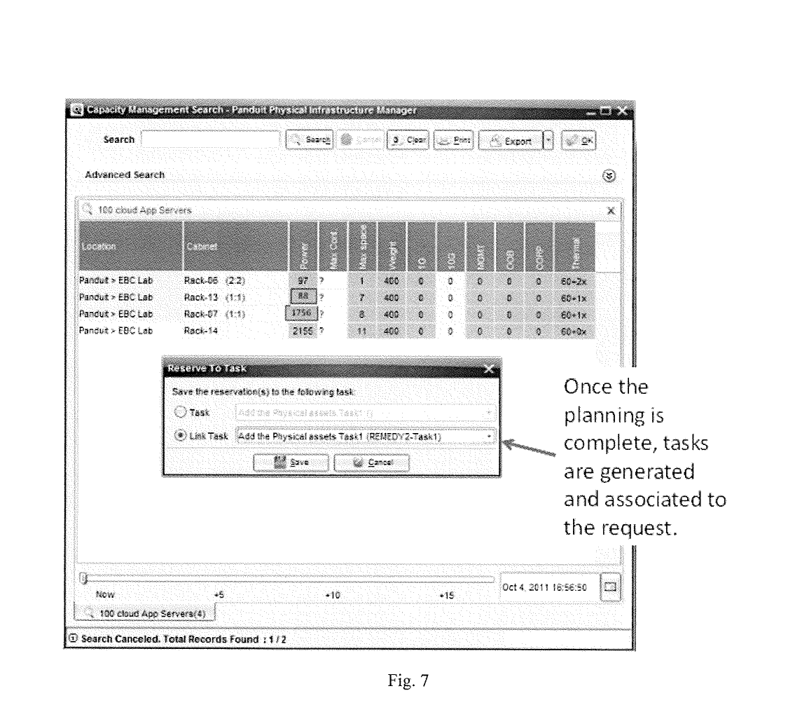

This dynamic update feature may be helpful in that guard band violations can be easily visualized and therefore the undesirable features of a planned upgrade or downgrade can be worked out virtually, prior to physical implementation. For example, a user faced with the virtual projections illustrated in FIG. 6 may determine that there is a need to avoid a guard band violation associated with the 10 G port. He can then make further virtual changes, adding or removing various devices from various racks until a satisfactory result is reached. An example of this is shown in FIG. 7, where after having noticed the guard band violation on rack-13, the user virtually removes one device from that rack and installs it in rack-07. Since rack-07 had one available 10 G port, and only one 10 G port is necessary for the one device virtually installed, no guard band violations, which would cause a rack to appear bronze, are caused. Additionally, the power and thermal capacity availability levels are also automatically updated.

The “What-if? Planning” module of the currently described embodiment also includes a slide-out forecast tool. This feature allows the user to slide a marker to a particular number of days and view how the virtual changes will impact the capacity levels of the shown racks based on forecasting models previously described. For example, if a change, which will bring the available number of 10 G ports in rack-06 from two (originally shown in FIG. 5) to zero, is planned in five days from the day that the user making the virtual changes, the user may not realize that installing any additional devices in rack-06 with 10 G connectivity would cause a guard band violation after the planned change takes effect. This can be avoided by forecasting the guard band violations past five days.

In alternate embodiments, the search results can immediately take into account any planned equipment installations (additions), limiting the returned physical locations to those which have not yet been reserved. In this embodiment, the slide-out forecast tool will change the search results based on future equipment removals but not on equipment additions. For example, if a separate service request, which will bring the available number of 10 G ports in rack-06 from two (originally shown in FIG. 5) to zero, has been scheduled to take place five days from the day that the user making the virtual changes, rack-06 will not be visible in the search results (presuming that the SLA during the search request was set to silver and the bronze guard band has been pre-defined to include any location where the number of 100 ports that is less than two). On the other hand, if the same rack (rack-06) has a planned service request to remove equipment which will result in two 10 G ports becoming available ten days from the day that the user is making the virtual changes, rack-06 will become visible in the search results if the user slides the slide-out forecast tool past the ten-day mark.

When the virtual additions of all necessary equipment are complete, the user can generate a work order, reserving selected racks for the service request, as shown in FIG. 7. As noted earlier, the user has virtually inserted all the necessary network equipment into the rack without causing any undesired guard band violations; all racks are highlighted silver, which fulfills the search criteria indicated in the capacity search.

The generated work order can be received by a technician, who can then proceed to physically install the required network equipment into the corresponding physical locations. After completing the tasks, the user can return to the dashboard to see how the changes have impacted the datacenter. Similarly, the user can return to the task manager to proceed working on the remaining tasks.

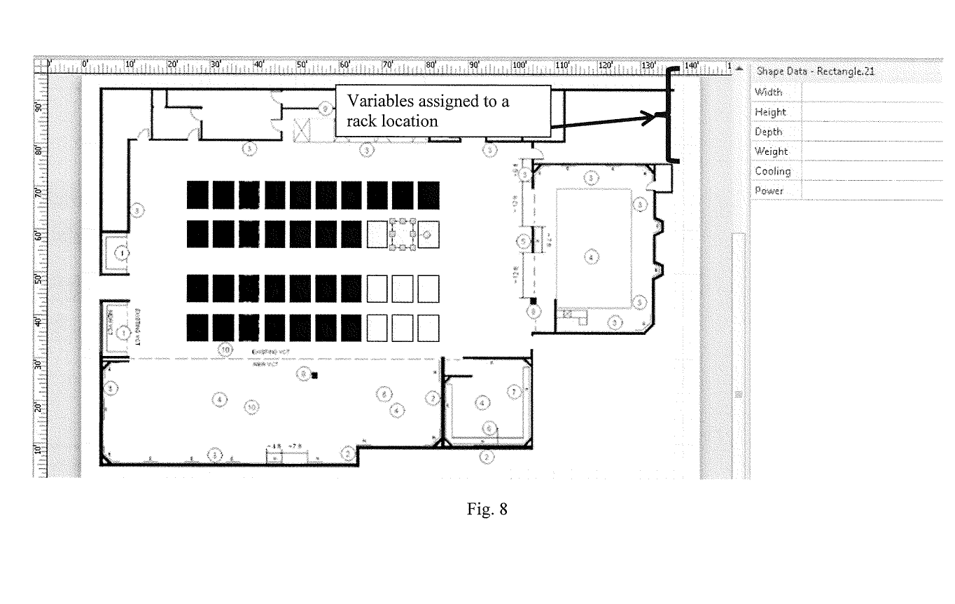

The present invention can also be extended to provision racks as well. This means that in certain embodiments, the present invention can be used for capacity planning of complete racks already populated with network equipment. Typically, when a datacenter is designed, rack locations are included in the blueprints in order to identify where key components such as cooling, power, and connectivity are to be installed. Each rack position in the datacenter can include an associated capacity for power, weight, cooling, cabling, floor space, and other characteristics that can be entered into the system and stored/used for provisioning these racks. Information regarding these blueprints and the associated capacities can be entered into the system of the present invention. In one embodiment, shown in FIG. 8, the user can view a blueprint of the datacenter with all available rack locations. The user can then select any of these locations to view, enter, or modify the corresponding capacity information for that location. This information is later used in provisioning of racks.

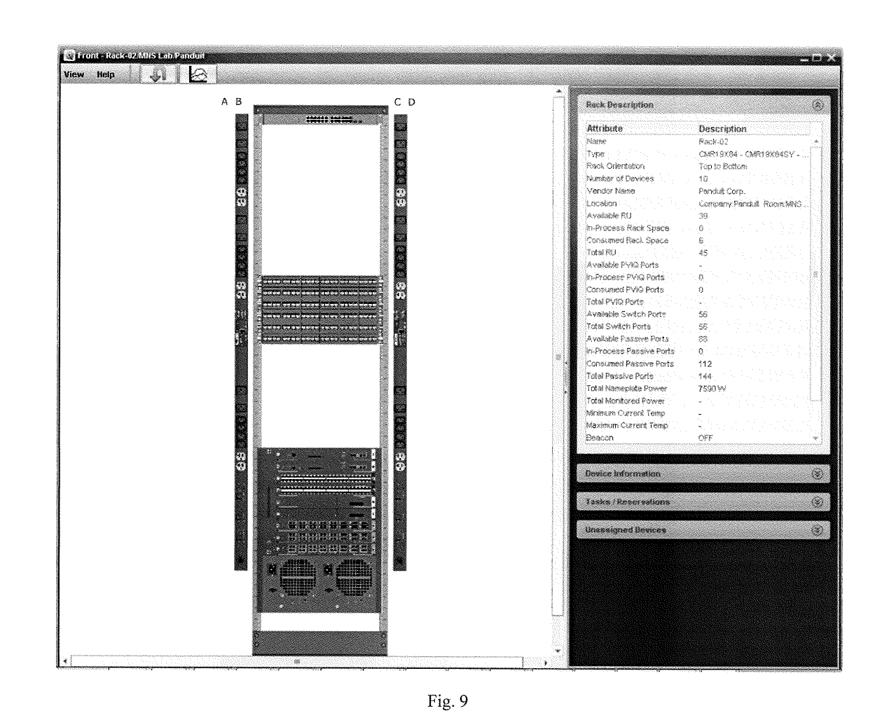

At the same, the user can set up virtual models of racks that need to be provisioned. This can be done by virtually assembling a rack in a virtual rack model module. An example of such a module is illustrated in FIG. 9. Here, a user can input all the necessary information/characteristics regarding the rack being provisioned. This information can include, but is not limited to, cooling, power, weight, connectivity, rack size, floor space, and particular networking equipment. Furthermore, the present invention may be linked to a database which provides at least some of the information necessary for provisioning based on the make/model of the equipment being installed. In this embodiment, the user can obtain the necessary consumption information by entering the make and model of the network equipment being virtually installed.

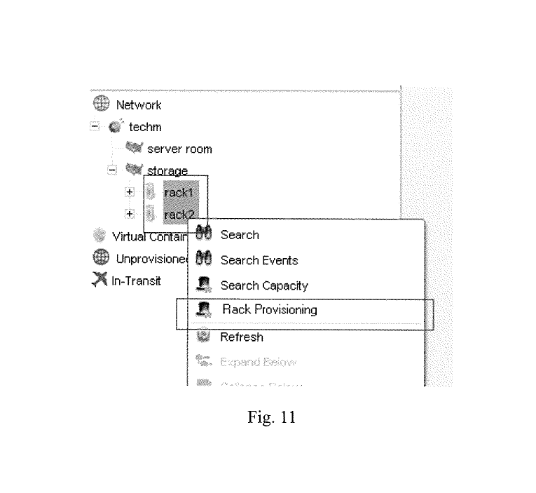

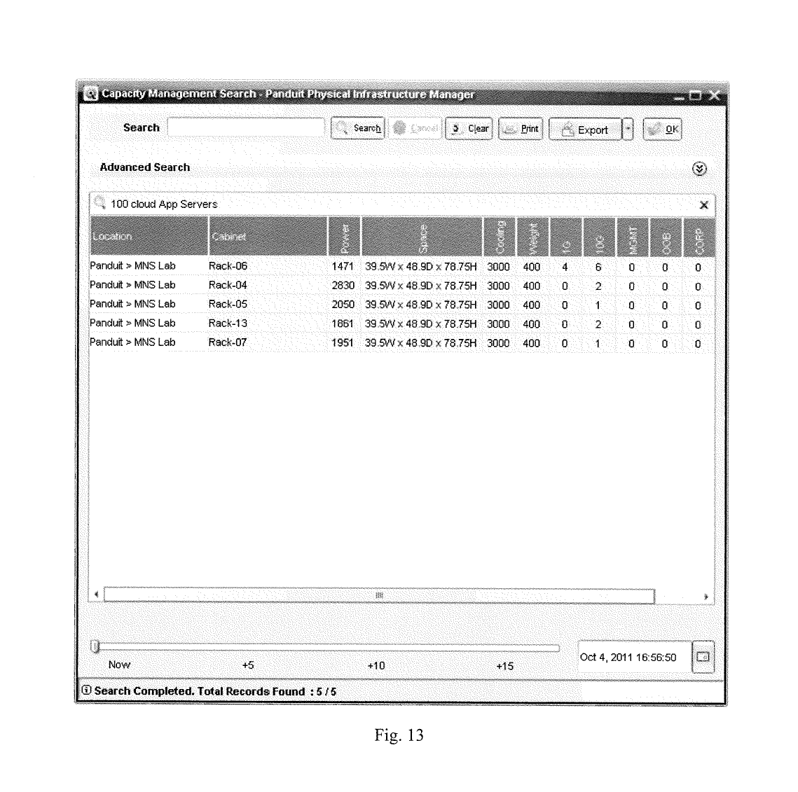

Once a rack has been virtually modeled, it appears in the Infrastructure Manager module of the present invention. This module can provide a list of racks that have been completed and are ready to be provisioned, racks which have successfully been provisioned and have had associated physical locations already reserved, and/or racks which have already been physically installed in the datacenter. An example of such module is shown in FIG. 13 which shown a list of racks by way of a location tree. The user can select any particular rack to view and modify its associated characteristics. From the Infrastructure Manager module, the user can initiate rack provisioning, as illustrated in FIG. 11. This can be done by selecting any one or more of the racks and requesting that the system begin the required operations.

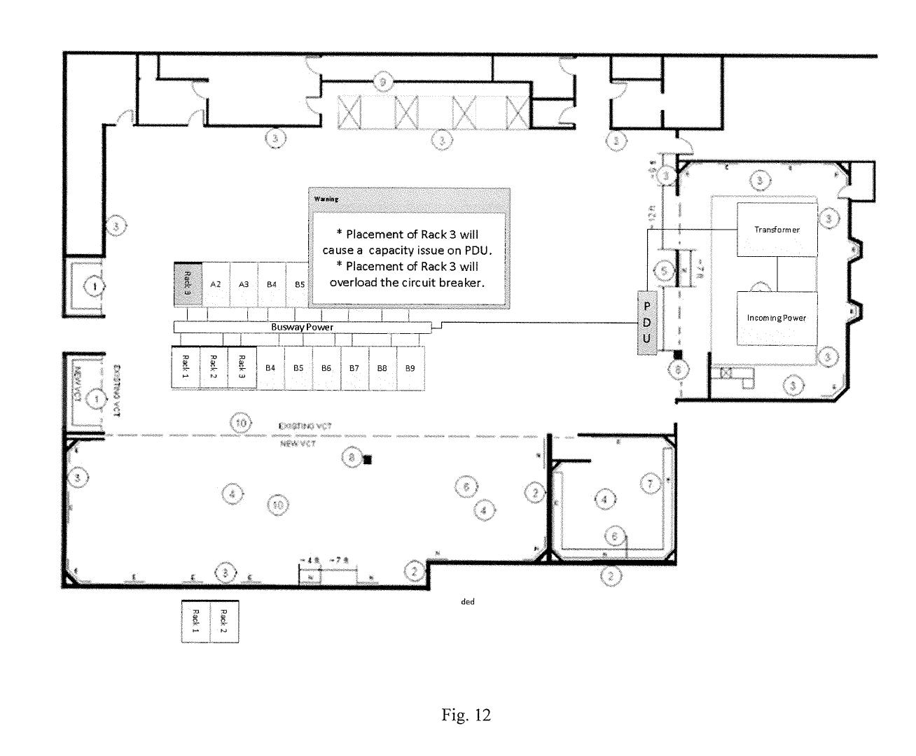

The present invention allows the user to provision for racks through at least two separate modules. The first provisioning module, illustrated in FIG. 12, outputs a blueprint-like view of a datacenter with various physical locations allocated for racks. Physical locations which are already occupied by equipment can be shaded, or identified by any suitable means, to warn the user that these locations are unavailable for new rack installations. Similarly, locations which have been reserved, but have not had any equipment installed therein, can also be identified by shading, patterning, or any other suitable means. The first provisioning module further outputs a series of racks that the user has virtually built and is provisioning. These can be in a form of rack-icons aligned along the periphery of the blueprint-like view of the datacenter. The user can proceed to drag any one of the rack-like icons (each representing a virtual rack) and drop it into the desired physical rack location shown on the blueprint-like view.

The first provisioning module can then compare the requirements of the virtual rack to the capacity characteristics of the selected physical rack location to determine whether the selected location can support a rack corresponding to the virtual rack that is being provisioned. The capacity characteristics can be calculated or obtained from a variety of sources, including information entered earlier by the user (as illustrated and discussed in FIG. 8), real-time sensing equipment such as a power distribution unit (PDU) that is capable of determining current and remaining power capacities for a given power line, and forecasting data obtained from forecasting models discussed previously.

If an allocated rack location can support a virtual rack that was drag-and-dropped therein without any guard band violations or other potential concerns, the user can be notified of this and that particular physical location can be further reserved for future installation of the rack. Similarly, the user can be notified of any potential concerns or guard band violations if the selected location does not or may not have sufficient available capacity to satisfy the capacity requirements of a virtual rack or to stay within a certain guard band level. An instance of a potential concern is illustrated in FIG. 12 where after attempting to drag-and-drop Rack 3 into physical location A1 the first provisioning module determines that the PDU may no longer be able to support the series of racks that is would be providing power to. This potential problem is made known to the user. The first provisioning module can further indicate (by highlighting, or otherwise suitably identifying) the component that lacks or may lack the required available capacity. In the present embodiment, because the PDU may not have sufficient capacity, it is highlighted for easier identification.

The user may also chose to employ a second provisioning module. This module can perform a search of the available datacenter locations and output only those locations which will satisfy a particular search request. Such a search request can be similar in nature to the search request shown and described in FIG. 4, in that the user can specify a specific guard band level needed to fulfill the request and as a result obtain physical locations having only that particular level or better. Furthermore, a slide-out forecast tool can also be used to eliminate or include physical locations which would fall under the required guard band level at some future date.

Note that while this invention has been described in terms of one or more embodiment(s), these embodiment(s) are non-limiting, and there are alterations, permutations, and equivalents, which fall within the scope of this invention. It should also be noted that there are many alternative ways of implementing the systems, methods, and apparatuses of the present invention. It is therefore intended that claims that may follow be interpreted as including all such alterations, permutations, and equivalents as fall within the true spirit and scope of the present invention.

We claim:

1. A system for monitoring at least one datacenter variable, said system comprising:
at least one processor; and
a computer readable medium connected to said at least one processor, said computer readable medium including instructions for collecting respective input information associated with a plurality of said datacenter variables, analyzing at least one work order associated with said datacenter, projecting consumption of at least one said datacenter variable based on said work order, and forecasting at least one of a capacity and a utilization of at least one said datacenter variable.

2. The system of claim 1, wherein said plurality of datacenter variables include a networking capacity variable, a weight capacity variable, a connectivity capacity variable, a space capacity variable, and a cooling capacity variable.

3. The system of claim 2, wherein said computer readable medium further includes instructions for determining at least one location within said datacenter for executing said work order.

4. The system of claim 3, wherein said instructions for determining determine an availability of space within said datacenter for a networking equipment.

5. The system of claim 2, wherein each of said capacities includes at least one of an amount used and an amount remaining.

6. The system of claim 2, wherein said instructions for forecasting includes temporal information of at least one of an amount of a total, an amount of a utilized, an amount of available, and an amount of change, of at least one of said datacenter variables.

7. The system of claim 1, wherein said computer readable medium further includes instructions for calculating a guard band for at least one said datacenter variable.

8. The system of claim 7, wherein said at least one said datacenter variable includes a networking capacity variable, a weight capacity variable, a connectivity capacity variable, a space capacity variable, and a cooling capacity variable.

9. The system of claim 8, wherein at least one said guard band includes a capacity utilization of at least one said datacenter variable.

10. The system of claim 9, wherein said computer readable medium further includes instructions for determining at least one location within said datacenter for executing said work order.

11. The system of claim 10, wherein said instructions for determining determine an availability of space within said datacenter for a networking equipment.

12. The system of claim 11, wherein at least one guard band level provides an upper limit restricting said at least one location to having at least one of a selected capacity utilization and a better capacity utilization.

13. The system of claim 10, wherein at least one said guard band includes a ranking of at least one of a low capacity utilization, a moderate capacity utilization, and a critical capacity utilization.

14. The system of claim 1, wherein said at least one processor is part of at least one of a server, a switch, a router, a disk array, a network attached storage system, an intelligent patch panel, a patch panel, a power distribution unit, and a rack appliance.

15. A method of forecasting at least one datacenter variable, the method including the steps of:
collecting respective input information associated with a plurality of said datacenter variables;
analyzing at least one work order associated with said datacenter;
projecting consumption of at least one said datacenter variable based on a work order; and
predicting at least one of a capacity and a utilization of at least one said datacenter variable.

16. The method of claim 15, further including the step of calculating a guard band for at least one said datacenter variable.

17. The method of claim 16, further including the step of determining at least one location within said datacenter for executing said work order.

18. The method of claim 17, wherein said calculating step provides an upper limit restricting said at least one location to having at least one of a selected capacity utilization and a better capacity utilization.

19. The method of claim 15, further including the step of determining at least one location within said datacenter for executing said work order.

20. The method of claim 19, wherein said determining step identifies a plurality of spaces within said datacenter for a networking equipment.

21. The method of claim 15, wherein said predicting step includes temporal-based information of at least one of an amount of a total, an amount of a utilized, an amount of an available, and an amount of change, of at least one of said datacenter variables.
